(19) United States
(12) Patent Application Publication
(10) Pub. No.: US 2016/0014799 A1
(43) Pub. Date: Jan. 14, 2016

(54) A METHOD FOR SCHEDULING OF RADIO RESOURCES TO USER TERMINALS OF DIFFERENT NETWORK OPERATORS, AND A BASE STATION THEREFOR

(71) Applicant: Alcatel Lucent, Boulogne Billancourt (FR)

(72) Inventors: Osman Aydin, Stuttgart (DE); Stefan Valentin, Stuttgart (DE)

(21) Appl. No.: 14/377,281

(22) PCT Filed: Jan. 18, 2013
(86) PCT No.: PCT/EP2013/050901

§ 371 Date: Aug. 7, 2014

(30) Foreign Application Priority Data
Feb. 9, 2012 (EP) 12305139.3

(51) Int. Cl. H04W 72/12

(52) U.S. Cl. CPC H04W 72/1226

(57) ABSTRACT

The invention concerns a method for scheduling of radio resources to user terminals (UE11-UE24) of different network operators using a scheduling unit, wherein the scheduling unit determines weight parameters for the user terminals (UE11-UE24) of the different network operators for scheduling of the radio resources based on a predefined distribution of radio resources among the different network operators (sᵢ) and at least one data throughput per user terminal in a time interval (Tᵢⱼ), and the scheduling unit schedules the radio resources to the user terminals (UE11-UE24) of the different network operators based on said weight parameters, and a base station therefor.

### FIELD OF THE INVENTION

The invention relates to a method for scheduling of radio resources to user terminals of different network operators using a scheduling unit, and a base station adapted to perform said method.

### BACKGROUND

In wireless communication networks, such as Third Generation Partnership Project Long Term Evolution (3GPP LTE), in order to improve efficiency and to reduce cost, it becomes more and more popular to share resources between different network operators. The sharing of resources can be accomplished in different ways. One possibility is to share parts of the infrastructure of a wireless communication network, as e.g. the base station or the backhaul network. A further method is to share the transmission spectrum. Of course also both of these possibilities can be combined.

The principle of sharing a base station between different network operators, which is also called base station virtualization, is that one physical base station hosts two or more virtual base stations. The internal components of a base station, like central processing unit (CPU), memory, or radio and backhaul network interfaces have to be virtualized or have to support virtualization. Every network operator owns one virtual base station and may run its own operational software on this virtual base station.

### SUMMARY

The realization of a joint, i.e. virtualized base station can be envisaged on different so-called OSI-layers (OSI=Open Systems Interconnections), as e.g. on Internet Protocol (IP), Media Access Control (MAC), or physical layer.

However, any method for scheduling of radio resources to user terminals of different network operators should guarantee a certain degree of fairness between the network operators, and should introduce only insignificant delay by sharing the radio resources among the different network operators.

The object of the invention is thus to propose a method for scheduling of radio resources, as e.g. so-called resource elements or resource blocks, to user terminals of different network operators, which offers a certain degree of fairness between the network operators without introducing a significant delay to the scheduling procedure.

The basic idea of the invention is, that a scheduling unit determines weight parameters for the user terminals of the different network operators for scheduling of the radio resources based on a predefined distribution of radio resources among the different network operators and a data throughput per user terminal in a time interval, and that the scheduling unit schedules the radio resources to the user terminals based on said weight parameters.

In an embodiment of the invention, in case of at least a shared or jointly used MAC layer for physical layer sharing, the MAC scheduling unit tracks or must be provided with trace-able performance parameters of the scheduling and its result, as e.g. a scheduled data rate and a related radio link quality for the user terminals of the different network operators.

In order to fulfil the above-mentioned requirements for a scheduling unit for scheduling of radio resources to the user terminals of the different network operators, two aspects are covered according to embodiments of the invention. The first aspect is, that a scheduler architecture according to the state of the art is extended by new adaptation blocks that adjust the scheduling parameters for each network operator according to an agreed contract, i.e. according to a predefined distribution of radio resources among the different network operators. The second aspect is to describe, how new operator-specific scheduling parameters are incorporated into scheduling algorithms according to the state of the art.

Thus, according to embodiments of the invention, techniques for user-based scheduling according to the state of the art are transformed to new principles to schedule multiple network operators. To this end, the following new regulations and concepts of a MAC scheduling unit in a shared base station for different network operators is introduced.

The MAC scheduling unit can e.g. be controlled via the following parameters:
new static input parameters for the scheduling unit dedicated to the different network operators sharing the base station, as e.g. an indication of a distribution of the radio resources between the different network operators,
new output parameters of the scheduling unit that tune new input parameters of the scheduling unit, as e.g. a data throughput per user terminal that tunes a weight parameter for scheduling of radio resources,
or a combination of both principles, i.e. of static input parameters and dynamic input parameters with feedback, in a single scheduling step.

In an embodiment of the invention, a shared scheduling unit tracks a quality of service (QoS) per user terminal and thus per network operator, which will have influence on the billing for the network operators for the use of a base station.

The object of the invention is thus achieved by a method for scheduling of radio resources to user terminals of different network operators using a scheduling unit, wherein
the scheduling unit determines weight parameters for the user terminals of the different network operators for scheduling of the radio resources based on a predefined distribution of radio resources among the different network operators and a data throughput per user terminal in a time interval,
and the scheduling unit schedules the radio resources to the user terminals of the different network operators based on said weight parameters.

The object of the invention is furthermore achieved by a base station comprising a scheduling unit for scheduling of radio resources to user terminals of different network operators, wherein
the scheduling unit is adapted to determine weight parameters for the user terminals of the different network operators for scheduling of the radio resources based on a predefined distribution of radio resources among the different network operators and a data throughput per user terminal in a time interval,
and the scheduling unit is adapted to schedule the radio resources to the different network operators based on said weight parameters.

The invention is described in the following within the frame-work of 3GPP LTE, however as the invention is not restricted to 3GPP LTE or enhancements thereof, but can in principle be applied in other networks that apply scheduling principles, like e.g. in WiMAX networks (WiMAX=Worldwide Interoperability for Microwave Access), in the following, instead of the term eNodeB used in LTE, the more general term base station is used.

Further developments of the invention can be gathered from the dependent claims and the following description.

### BRIEF DESCRIPTION OF THE FIGURES

In the following the invention will be explained further making reference to the attached drawings.

FIG. 1 schematically shows a communication network in which the invention can be implemented.

FIG. 2 schematically shows the structure of a user terminal and a base station in which the invention can be implemented.

FIG. 3 schematically shows the flow of input and output parameters of a MAC scheduling unit according to an embodiment of the invention.

FIG. 4 schematically shows a joint operator and user terminal scheduling unit according to an embodiment of the invention.

### DESCRIPTION OF THE EMBODIMENTS

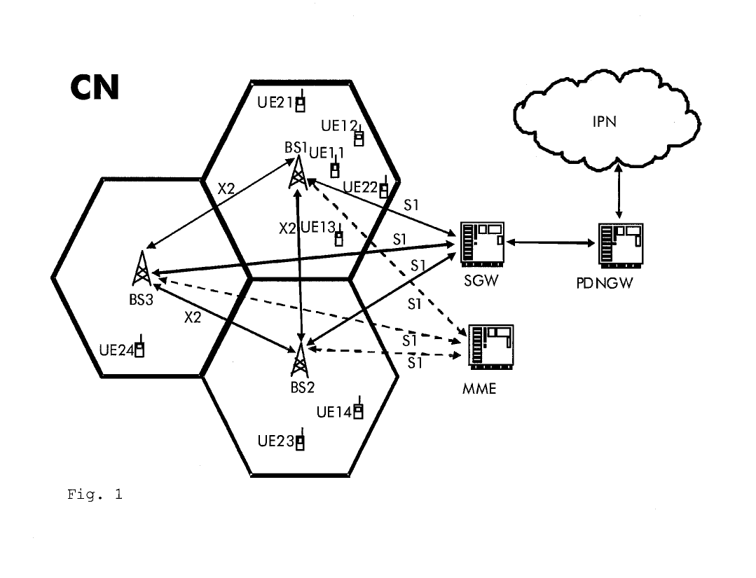

FIG. 1 shows as an example of a communication network in which the invention can be implemented a communication network CN according to the standard 3GPP LTE.

Said communication network CN comprises base stations BS1, . . . , BS3, user terminals UE11-UE24, a serving gateway SGW, a packet data network gateway PDNGW, and a mobility management entity MME.

The user terminals UE11-UE13 and UE21-UE22 are connected via radio connections to the base station BS1, the user terminals UE14 and UE23 are connected via radio connections to the base station BS2, and the user terminal UE24 is connected via a radio connections to the base station BS3. In future evolutions of LTE, each of the user terminals UE11-UE14 and UE21-UE24 could also be connected via radio connections to multiple of said base stations BS1, . . . , BS3.

The base stations BS1, . . . , BS3 are in turn connected to the serving gateway SGW and to the mobility management entity MME, i.e. to the evolved packet core (EPC), via the so-called S1 interface.

The base stations BS1-BS3 are connected among each other via the so-called X2 interface.

The serving gateway SGW is connected to the packet data network gateway PDNGW, which is in turn connected to an external IP network IPN.

The S1 interface is a standardized interface between one of the base stations BS1, . . . , BS3, i.e. an eNodeB in this example, and the Evolved Packet Core (EPC). The S1 interface has two flavours, S1-MME for exchange of signalling messages between one of the base stations BS1, . . . , BS3 and the mobility management entity MME and S1-U for the transport of user datagrams between one of the base stations BS1-BS3 and the serving gateway SGW.

The X2 interface is added in 3GPP LTE standard primarily in order to transfer the user plane signal and the control plane signal during handover.

The serving gateway SGW performs routing of the IP user data between the base stations BS1, . . . , BS3, and the packet data network gateway PDNGW. Furthermore, the serving gateway SGW serves as a mobile anchor point during handover either between different base stations, or between different 3GPP access networks.

The packet data network gateway PDNGW represents the interface to the external IP network IPN and terminates the so-called EPS bearer (EPS=Evolved Packet System) which is established between a user terminal and the respective serving base station BS1, . . . , BS3.

The mobility management entity MME performs tasks of the sub-scriber management and the session management, and also performs the mobility management during handover between different access networks.

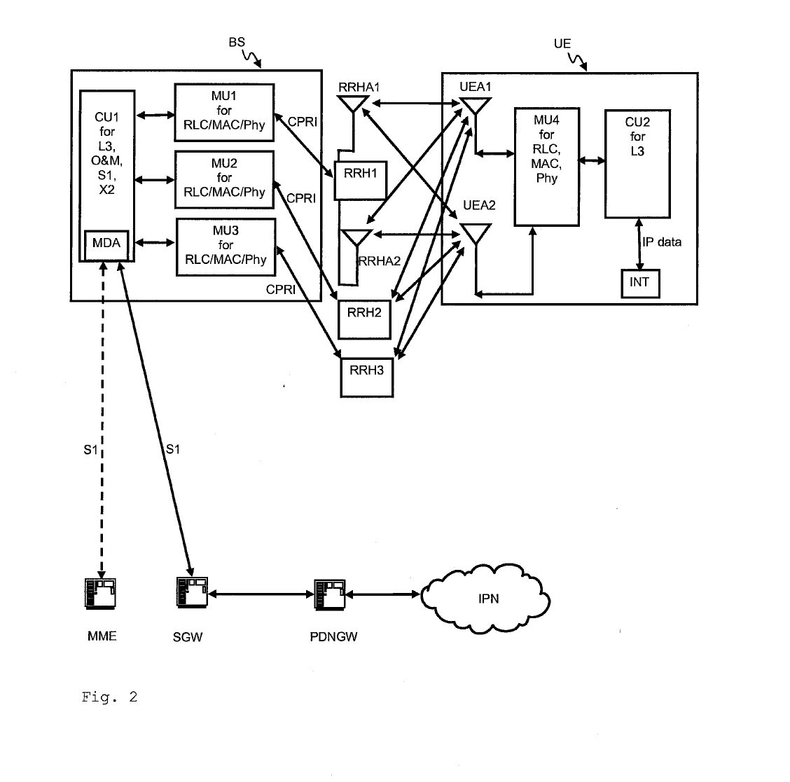

FIG. 2 schematically shows the structure of a user terminal UE and a base station BS in which the invention can be implemented.

The base station BS comprises by way of example three modem unit boards MU1-MU3 and a control unit board CU1, which in turn comprises a media dependent adapter MDA.

The three modem unit boards MU1-MU3 are connected to the control unit board CU1, and to a respective remote radio head RRH1, RRH2, or RRH3 via a so-called Common Public Radio Interface (CPRI).

Each of the remote radio heads RRH1, RRH2, and RRH3 is connected by way of example to two remote radio head antennas RRHA1 and RRHA2 for transmission and reception of data via a radio interface. Said two remote radio head antennas RRHA1 and RRHA2 are only depicted for the remote radio head RRH1 in FIG. 2 for the sake of simplicity.

The media dependent adapter MDA is connected to the mobility management entity MME and to the serving gateway SGW and thus to the packet data network gateway PDNGW, which is in turn connected to the external IP network IPN.

The user terminal UE comprises by way of example two user terminal antennas UEA1 and UEA2, a modem unit board MU4, a control unit board CU2, and interfaces INT.
The two user terminal antennas UEA1 and UEA2 are connected to the modem unit board MU4. The modem unit board MU4 is connected to the control unit board CU2, which is in turn connected to interfaces INT.

The modem unit boards MU1-MU4 and the control unit boards CU1, CU2 may comprise by way of example Field Programmable Gate Arrays (FPGA), Digital Signal Processors (DSP), micro processors, switches and memories, like e.g. Double Data Rate Synchronous Dynamic Random Access Memories (DDR-SDRAM) in order to be enabled to perform the tasks described below.

The remote radio heads RRH1, RRH2, and RRH3 comprise the so-called radio equipment, e.g. modulators and amplifiers, like delta-sigma modulators (DSM) and switch mode amplifiers.

In downlink, IP data received from the external IP network IPN are transmitted from the packet data network gateway PDNGW via the serving gateway SGW to the media dependent adapter MDA of the base station BS on an EPS bearer. The media dependent adapter MDA allows for a connectivity to different media like e.g. fiber or electrical connection.

The control unit board CU1 performs tasks on layer 3, i.e. on the radio resource control (RRC) layer, such as measurements and cell reselection, handover and RRC security and integrity.

Furthermore, the control unit board CU1 performs tasks for Operation and Maintenance, and controls the S1 interfaces, the X2 interfaces, and the Common Public Radio Interface.

The control unit board CU1 sends the IP data received from the serving gateway SGW to a modem unit board MU1-MU3 for further processing.

The three modem unit boards MU1-MU3 perform data processing on layer 2, i.e. on the PDCP layer (PDCP=Packet Data Convergence Protocol) which is e.g. responsible for header compression and ciphering, on the RLC layer (RLC=Radio Link Control) which is e.g. responsible for segmentation and Automatic Repeat Request (ARQ), and on the MAC layer (MAC=Media Access Control) which is responsible for MAC multiplexing and Hybrid Automatic Repeat Request (HARQ).

Furthermore, the three modem unit boards MU1-MU3 perform data processing on the physical layer, i.e. coding, modulation, and antenna and resource-block mapping.

The coded and modulated data are mapped to antennas and resource blocks and are sent as transmission symbols from the modem unit board MU1-MU3 over the Common Public Radio Interface to the respective remote radio head RRH1, RRH2, or RRH3, and the respective remote radio head antenna RRHA1, RRHA2 for transmission over an air interface.

The Common Public Radio Interface (CPRI) allows the use of a distributed architecture where base stations BS, containing the so-called radio equipment control, are connected to remote radio heads RRH1, RRH2, and RRH3 preferably via lossless fibre links that carry the CPRI data. This architecture reduces costs for service providers because only the remote radio heads RRH1, RRH2, and RRH3 containing the so-called radio equipment, like e.g. amplifiers, need to be situated in environmentally challenging locations. The base stations BS can be centrally located in less challenging locations where footprint, climate, and availability of power are more easily managed.

The user terminal antennas UEA1, UEA2 receive the transmission symbols, and provide the received data to the modem unit board MU4.

The modem unit board MU4 performs data processing on the physical layer, i.e. antenna and resource-block demapping, demodulation and decoding.

Furthermore, the modem unit board MU4 performs data processing on layer 2, i.e. on the MAC layer (MAC=Media Access Control) which is responsible for Hybrid Automatic Repeat Request (HARQ) and for MAC demultiplexing, on the RLC layer (RLC=Radio Link Control) which is e.g. responsible for reassembly and Automatic Repeat Request (ARQ), and on the PDCP layer (PDCP=Packet Data Convergence Protocol) which is e.g. responsible for deciphering and header compression.

The processing on the modem unit board MU4 results in IP data which are sent to the control unit board CU2, which performs tasks on layer 3, i.e. on the radio resource control (RRC) layer, such as measurements and cell reselection, handover and RRC security and integrity.

The IP data are transmitted from the control unit board CU2 to respective interfaces INT for output and interaction with a user.

In the uplink, data transmission is performed in an analogue way in the reverse direction from the user terminal UE to the external IP network IPN.

In the sequel, the usage of base station BS as described above as a virtual base station with a shared scheduling unit for scheduling of multiple network operators is described according to embodiments of the invention.

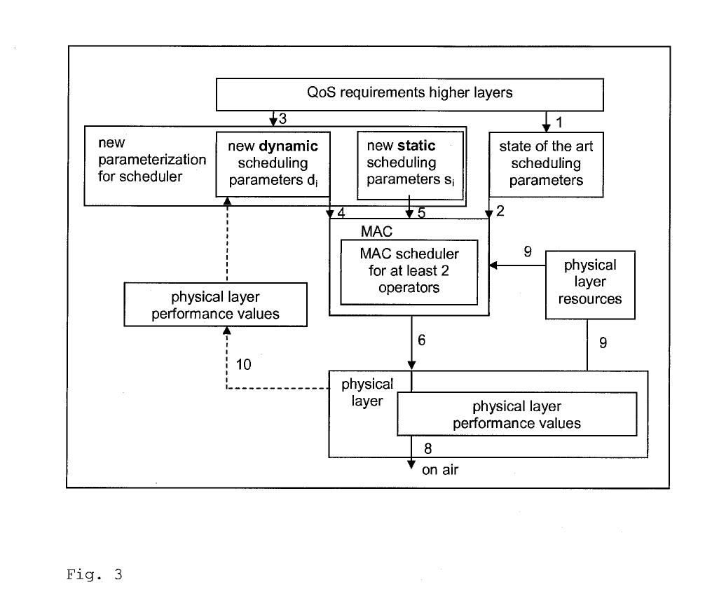

FIG. 3 schematically shows the flow of input and output parameters of a MAC scheduling unit according to an embodiment of the invention.

Said method for performing MAC scheduling for at least two network operators can e.g. be implemented in one of the modem unit boards MU1-MU3 as depicted in FIG. 2 and described above.

As basic input parameters, quality of service (QoS) requirements for various user terminals are used to determine scheduling parameters.

In a scheduling method for radio resources according to the state of the art for only one network operator, said QoS requirements of the user terminals are used in a step 1 to determine scheduling parameters, which are transmitted in a step 2 to the MAC scheduling unit. In the MAC scheduling unit, said QoS requirements, as e.g. required transmission delay or required data throughput of the user terminals, are compared to the current achieved delay and data throughput of the user terminals, and preferably the user terminals are scheduled in such a way, that for all user terminals the QoS requirements are fulfilled.

In a scheduling method for radio resources according to an embodiment of the invention for multiple network operators, said QoS requirements of the user terminals are transmitted in a step 3 to a processing block, in which scheduling parameters for the MAC scheduling unit are stored or determined. In an alternative of the embodiment, said QoS requirements of the user terminals are used to determine dynamic scheduling parameters dᵢ for the user terminals of each operator i, which can change from one scheduling interval to another. Said dynamic scheduling parameters dᵢ are transmitted to the MAC scheduling unit in step 4.

According to the embodiment of the invention, also static scheduling parameters sᵢ, which either do not change or only change on a longer time scale compared to the dynamic scheduling parameters dᵢ, are transmitted to the MAC scheduling unit in step 5.

The MAC scheduling unit uses both the dynamic parameters dᵢ, and the static parameters sᵢ to determine weight parameters for the user terminals of the different operators for scheduling of radio resources to the user terminals. Therefor, a priority handling of different RLC buffers, and a transport-format selection, i.e. a selection of transport block size, modulation scheme and antenna mapping, for each user terminal is performed by the MAC scheduling unit, and respective commands are transmitted to the physical layer in step 6. On the physical layer, coding, modulation, antenna mapping, mapping on resource blocks or elements, and transmission over an air interface of the scheduled data is performed in step 8.

The physical layer provides information about available physical layer resources to the MAC scheduling unit in step 9, which schedules the available physical layer resources, i.e. radio resources, to the user terminals as described above.

In a further embodiment of the invention, physical layer performance values, such as data rates per user terminal or per network operator, are determined on a longer time scale, such as several scheduling cycles. Said physical layer performance values are provided as input parameters for a scheduling method for determination of scheduling parameters in step 10 in order to assure long-term fairness and stability among the network operators. If e.g. the data rate for a first network operator on such a longer time-scale is lower than an agreed data rate, and the data rate for the other network operators is above their agreed data rate, then user terminals of the first network operator are scheduled with a higher priority. Furthermore, said physical layer performance values are used for billing of the use of the base station, and are transmitted to the different network operators.

According to an embodiment of the invention, the scheduling of radio resources to user terminals of different network operators is performed in two scheduling steps in the MAC scheduling unit. In a first scheduling step, the radio resources are scheduled to the different network operators based on a predefined distribution of radio resources among the different network operators, and in a second scheduling step, the radio resources are scheduled per network operator to the user terminals based on a data throughput per user terminal in a time interval.

Static parameters sᵢ that indicate the distribution of radio resources between the different network operators i are used to schedule the radio resources to the different network operators i. These static parameters sᵢ provide transparently for each network operator the frequency of occurrence for their user terminals, and can be used e.g. in a round robin or a proportional fair scheduler as described in the following.

Usage of a So-Called Round Robin Scheduler for Scheduling:

If according to an agreed frame contract, radio resource usage between the network operators is equally distributed, each of them get the value sᵢ=1, i.e. for the case of two network operators, one round robin loop will look like this: loop1: operator1, operator2. Loop2: operator1, operator2, . . . , thus, each network operator will be scheduled alternately.

In case the radio resource usage is regulated in an unequal way, e.g. the resource usage rate for the first network operator is ⅔ and for the second network operator is ⅓, then the first network operator gets the value s₁=2 and the second network operator gets the value s₂=1. So the first operator's user terminals are represented 2 times in the round robin loop, i.e. one round robin loop will look like this: loop1: operator1, operator1, operator2. Loop2: operator1, operator1, operator2 . . . .

Usage of a So-Called Proportional Fair Scheduler:

The classic proportional fair scheduling is transferred to the case of scheduling of multiple network operators. A proportional fair weight parameter wᵢ for each operator i is extended with static parameters sᵢ to support a multiple network operator case. The static parameter sᵢ is implemented into the numerator of wᵢ specific for each network operator.

wᵢ=(sᵢ·Rᵢ)/Tᵢi=1,2(operator1,operator2) (1)

The parameter Rᵢ in this case indicates a radio link quality averaged over the user terminals of the network operator i, and averaged over one or more elapsed scheduling cycles.

The parameter Tᵢ in this case indicates a data throughput averaged over the user terminals of the network operator i, and averaged over one or more elapsed scheduling cycles.

The static parameter sᵢ for each network operator i reflects the distribution of radio resources according to an agreed contract between the network operators, which is independent of the dynamics of a mobile communication network like the effective used radio resources for a physical transport block.

In alternatives of the embodiment, also QoS implications can be used for a tuning of the static parameter sᵢ:

The static parameter sᵢ for one network operator can be set to different values in a given interval to reflect the agreed QoS differences of user terminals for a specific network operator. The parameter sᵢ is chosen within the interval sᵢ=[0,1] such that

$${\sum }_{i} {s}_{i} \leq 1.$$

Within this constraint, the values are defined according to business agreements between the network operators and resource owner, which is lending base station hardware and spectrum to the network operators, e.g., s₁=0.3 and s₂=0.7.

To summarize, in a first scheduling step, the radio resources are scheduled to the different network operators based on a static parameter sᵢ using e.g. a round robin scheduler or a proportional fair scheduler.

Now that the radio resources are distributed between the different network operators, in a second scheduling step, the radio resources are scheduled per network operator to the user terminals.

Said scheduling in the second scheduling step can be performed by means of a proportional fair scheduler according to the state of the art, i.e. by means of a weight parameter wⱼ for each user terminal j

wⱼ=Rⱼ/Tⱼ (2)

with Rⱼ being a radio link quality of the user terminal j averaged over one or more elapsed scheduling cycles, and with Tⱼ being a data throughput averaged over one or more elapsed scheduling cycles.

Thus, in the second scheduling step, user terminals with a higher weight parameter wⱼ are scheduled first.

In an alternative embodiment for the second scheduling step, the proportional fair weight parameter wⱼ of the user terminal j is extended with a dynamic parameter. The dynamic parameter dⱼ can be implemented into the denominator of the weight parameter wⱼ, specific for each network operator according to

wⱼ=Rⱼ/(Tⱼ(dⱼ)) (3)

Alternative implementation may include the reciprocal of dⱼ in the numerator.

The dynamic parameter dⱼ reflects the distribution of radio resources according to the averaged used radio resources per user terminal for each network operator. So the dynamics of a mobile communication network like effective used radio resources for a user terminal for each network operator are considered in a proportional fair scheduler.

The dynamic parameter dⱼ can e.g. be determined based on the used radio resources per user terminal averaged over one or more scheduling cycles Uⱼ normalized by the overall available radio resources U_{ges} according to

dⱼ=k·Uⱼ/U_{ges} (4)

with k being a constant factor.

The dynamic parameter dⱼ can alternatively or additionally e.g. be determined based on the QoS differences of user terminals for a specific network operator, i.e. a higher QoS of a user terminal leads e.g. to a lower dynamic parameter dⱼ Said QoS differences of user terminals for a specific network operator can e.g. be predefined values agreed by contract or achieved, i.e. measured, values. The dynamic parameter dⱼ is adapted during the runtime according to the users' current QoS requirements. However, lower and upper bounds for this parameter can be fixed according to business contracts between network operators and resource owner.

In the case of a proportional fair scheduler, Tⱼ as being the data throughput averaged over one or more elapsed scheduling cycles, can be recursively determined with a forgetting factor b for scheduled user terminals, which is adapted specifically per user terminal for each network operator, and which is dependent on the dynamic parameter dᵢ according to

Tⱼ(t,dᵢ)=(1−bⱼ(dᵢ))·Tⱼ(t−1)+bⱼ(dᵢ)·Rᵢ(t−1) (5)

where Rⱼ(t−1) stands for the instantaneous data rate as sup-ported by the channel during time slot t−1. The forgetting factor bⱼ provides performance means to reschedule an arbitrary user terminal j at earlier or later points in time.

As an example, we assume one user terminal and two operators with an instantaneous data rate R₁(t)=R₁(t−1)=1 and average throughput T₁(t)=0.5. The dynamic weight parameter is d₁=0.25 for operator 1 and d₂=0.75 for operator 2. Assuming dᵢ=bⱼ(dᵢ) for simplicity yields T=0.625 and w₁=1.6 for operator 1 and T=0.875 and w₁=1.143 for operator 2. Since the dynamic parameter d affects the denominator of equation (3), the operator with lower d receives a higher weight w. Thus, operator 1 receives priority to schedule user 1 in the next cycle.

In alternatives of the above-described embodiments, a processing of the term Tⱼ by a non-linear function f that depends on the above-described dynamic parameter dⱼ, and further parameters, as e.g. the so-called scheduler-specific parameter α. This function is defined as

T*=f(Tⱼ,α,dⱼ) (8)

In the above-described embodiments, in a first scheduling step, the radio resources are scheduled to the different network operators, and in a second scheduling step, the radio resources are scheduled per network operator to the user terminals.

In the following, embodiments of the inventions are described in which scheduling of the radio resources to the user terminals of multiple network operators is performed in a single scheduling step, i.e. a joint operator and user terminal scheduling is performed that operates on all sets of user terminals for all network operators at once.

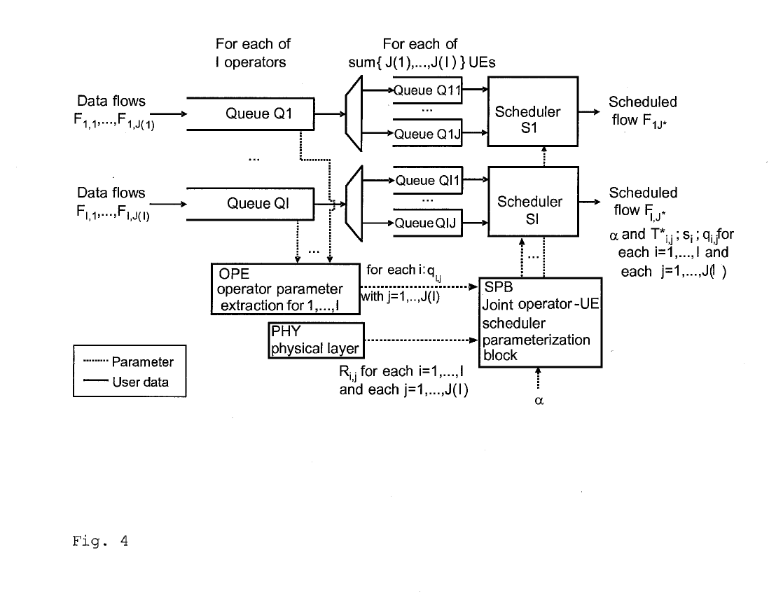

For this scheduling principle, FIG. 4 illustrates the basic design for I network operators and J(I) user terminals.

FIG. 4 schematically shows a joint operator and user terminal scheduling unit according to an embodiment of the invention.

The joint operator and user terminal scheduling unit comprises a queue Qᵢ for each of the I network operators. Each queue Qᵢ receives data flows Fᵢⱼ for each of the j(i) user terminals, i.e. the queues represent RLC buffers.

Each of said queues Qᵢ is connected to a processing block for network operator parameter extraction OPE, in which for each of the I network operators, a quality of service requirement qᵢⱼ for each of the j(i) user terminals is extracted out of said data flows Fᵢⱼ.

Furthermore each of said queues Qᵢ is connected via a multiplexer to a respective queue Qᵢⱼ for the different user terminals.

The queues Qᵢⱼ of each network operator i are connected to a respective MAC scheduler Sᵢ for scheduling the data flows Fᵢⱼ of the respective network operator i. In an alternative of the embodiment, said MAC schedulers S1, . . . , SI of the different network operators can be implemented in a single MAC scheduler for all I network operators.

A joint operator and user terminal scheduler parameterization block SPB determines weight parameters wᵢⱼ for scheduling the user terminals of the different network operators as described in detail below. Therefor, the joint operator and user terminal scheduler parameterization block SPB receives the quality service requirement for each of the j(i) user terminals from the processing block for network operator parameter extraction OPE, and receives from the physical layer PHY a radio link quality Rᵢⱼ for each of the j(i) user terminals. Preferably, the joint operator and user terminal scheduler parameterization block SPB also receives the so-called scheduler-specific parameter α. As the well-known fairness parameter, α adjusts the fairness type among the network operators, by choosing the utility function between proportional fairness, i.e. logarithmic utility, and max-rate fairness, i.e. linear utility. This static fairness parameter α is specified by the resource owner.

The joint operator and user terminal scheduler parameterization block SPB schedules the different MAC scheduler S1, . . . , SI in the order of the weight parameters wᵢⱼ, and the different MAC scheduler S1, . . . , SI receive the weight parameters wᵢⱼ and in turn schedule the different j(i) user terminals also in the order of the weight parameters wᵢⱼ.

In an alternative of the embodiment, if only a single scheduler is used, said scheduler receive the weight parameters wᵢⱼ and schedules for all I network operators the different j(i) user terminals in the order of the weight parameters wᵢⱼ.

Per scheduling cycle, an arbitrary network operator i=1, . . . , I has to serve J(i) user terminals. In this embodiment Of the invention, the network operators are not scheduled separately. Instead, a network operator scheduling is reflected within conventional user terminal based schedulers by adjusting the scheduling parameters. This extends the above-mentioned parameters as the data throughput per user terminal Tⱼ and the dynamic parameter dⱼ to parameters that are specific for each operator i=1, . . . , I and for each user terminal j=1, . . . , J(I).

In particular Tᵢⱼ is now the moving average of the data rate for an arbitrary user j that is associated to an arbitrary network operator i averaged over one or more elapsed scheduling cycles, while dᵢⱼ is now the dynamic parameter to calculate Tᵢⱼ for an arbitrary user terminal j that is associated to an arbitrary network operator i.

In case of a proportional fair scheduling unit, Tᵢⱼ can be recursively determined with a forgetting factor b for scheduled user terminals, which is adapted specifically per user terminal j and per network operator i, and which is dependent on the dynamic parameter dᵢⱼ according to

Tᵢⱼ(t,dᵢⱼ)=(1−bᵢⱼ(dᵢⱼ))·Tᵢⱼ(t−1)+bᵢⱼ(dᵢⱼ)·Rᵢⱼ(t−1) (9)

In case bᵢⱼ(dᵢⱼ)=dᵢⱼ is set, dᵢⱼ is the forgetting factor that is associated to an arbitrary network operator j and to an arbitrary user terminal j.

Again, as described above, the dynamic parameter dᵢⱼ reflects the distribution of radio resources according to the averaged used radio resources per user terminal j and per network operator i. So the dynamics of a mobile communication network like effective used radio resources for a user terminal for each network operator are considered in a proportional fair scheduler.

The dynamic parameter dᵢⱼ can e.g. be determined based on the used radio resources per user terminal and per network operator averaged over one or more scheduling cycles Uᵢⱼ normalized by the overall available radio resources U_{ges} according to

dᵢⱼ=k·UᵢⱼN_{ges} (10)

with k being a constant factor.

The dynamic parameter dᵢⱼ can alternatively or additionally e.g. be determined based on the QoS differences of user terminals of a specific network operator, i.e. a higher QoS of a user terminal leads e.g. to a lower dynamic parameter dᵢⱼ. Said QoS differences of user terminals for a specific network operator can e.g. be predefined values agreed by contract or achieved, i.e. measured, values.

Defining the dynamic parameters dᵢⱼ and the data throughput Tᵢⱼ, and obtaining the number of user terminals J(i) per operator i and the quality of service requirement qᵢⱼ for each user terminal j and each network operator i requires queue observation. As illustrated in FIG. 4, quality of service requirements qᵢⱼ are extracted by the processing block for network operator parameter extraction OPE, and the radio link qualities Rᵢⱼ are transmitted from the physical layer PHY. After transmission of parameters from higher layers and the physical layer PHY, as e.g. radio link quality Rᵢⱼ, i.e. channel stability, and service agreements, and after defining the dynamic parameters dᵢⱼ as described above, the data throughput Tᵢⱼ can be computed in the joint operator and user terminal scheduler parameterization block SPB, and in turn weight parameters wᵢⱼ for scheduling radio resources are calculated.

For each network operator and user terminal, the values of the data throughput Tᵢⱼ, the static parameter sᵢ reflecting the distribution of radio resources between the network operators, the quality of service requirements qᵢⱼ, and the radio link qualities Rᵢⱼ are used in the joint operator and user terminal scheduler parameterization block SPB to calculate weight parameters wᵢⱼ for scheduling radio resources as according to

$${w}_{ij} = \frac{{s}_{i} {q}_{ij} {R}_{ij}}{{T}_{ij}} . \qquad ( 11 )$$

In an alternative of the embodiment, the values of the data throughput Tᵢⱼ, the static parameter sᵢ reflecting the distribution of radio resources between the network operators, the quality of service requirements qᵢⱼ, and the radio link qualities Rᵢⱼ are transmitted to the schedulers S1, . . . , SI, or to a single scheduler in case only one scheduler is used for scheduling all I network operators, and used to calculate the weight parameters wᵢⱼ for scheduling radio resources as described above.

With said weight parameter computation and the architectural changes depicted in FIG. 4, scheduling among network operators has been integrated into existing user terminal schedulers without introducing an additional scheduling stage.

In an embodiment of the invention, an outer control loop to the schedulers S1, . . . , SI as indicated as step 10 in FIG. 3 is implemented. As illustrated in FIG. 3, this loop feeds the output of the I schedulers S1, . . . , SI to the parameterization block SPB. Here, this information can feed a further control cycle to assure long-term fairness and stability among the network operators. Furthermore, the base station owner can provide the observed scheduling decisions to the network operators for billing.

1. A method for scheduling of radio resources to user terminals of different network operators using a scheduling unit, wherein
the scheduling unit determines weight parameters for the user terminals of the different network operators for scheduling of the radio resources based on a predefined distribution of radio resources among the different network operators and data throughputs per user terminal in a time interval,
and the scheduling unit schedules the radio resources to the user terminals of the different network operators based on said weight parameters.

2. A method according to claim 1, wherein the scheduling unit determines said weight parameters based on used radio resources per user terminal in a time interval.

3. A method according to claim 1, wherein the scheduling unit determines said weight parameters based on agreed or achieved qualities of service per user terminal.

4. A method according to claim 1, wherein the scheduling unit determines said weight parameters based on radio link qualities per user terminal.

5. A method according to claim 1, wherein said predefined distribution of radio resources among the different network operators is set to values out of predefined intervals based on agreed qualities of service for the user terminals of the different network operators.

6. A method according to claim 1, wherein said scheduling of the radio resources to user terminals of different network operators is performed in a single scheduling.

7. A method according to claim 1, wherein in a first scheduling, the radio resources are scheduled to the different network operators based on said predefined distribution of radio resources among the different network operators, and in a second scheduling, the radio resources are scheduled per network operator to the user terminals based on said data throughputs per user terminal in the time interval.

8. A method according to claim 7, wherein for the first scheduling round robin scheduling is used, and for the second scheduling proportional fair scheduling is used.

9. A method according to claim 1, wherein said scheduling unit is a proportional fair scheduling unit.

10. A method according to claim 1, wherein said data throughputs are determined based on forgetting factors.

11. A method according to claim 1, wherein said data throughputs are weighted with at least one of a group of used radio resources per user terminal and achieved qualities of service per user terminal.

12. A method according to claim 1, wherein information about a performed scheduling of the radio resources on a time-scale of several scheduling intervals is used by the scheduling unit for determination of said weight parameters.

13. A method according to claim 1, wherein said information about a performed scheduling of the radio resources is transmitted to the different network operators and used for billing.

14. A method according to claim 1, wherein said scheduling is performed on at least one of a group of internet protocol layer, medium access control layer, and physical layer.

15. A base station comprising a scheduling unit for scheduling of radio resources to user terminals of different network operators, wherein
the scheduling unit is adapted to determine weight parameters for the user terminals of the different network operators for scheduling of the radio resources based on a predefined distribution of radio resources among the different network operators and data throughputs per user terminal in a time interval,
and the scheduling unit is adapted to schedule the radio resources the user terminals of the different network operators based on said weight parameters.
